(19) United States
(12) Patent Application Publication
(10) Pub. No.: US 2025/0208894 A1
(43) Pub. Date: Jun. 26, 2025

(54) DATA PROCESSING METHOD, APPARATUS, DEVICE AND STORAGE MEDIUM

(71) Applicant: CLOUD INTELLIGENCE ASSETS HOLDING (SINGAPORE) PRIVATE LIMITED, Singapore (SG)

(72) Inventors: Yufei MAI, Shanghai (CN); Fang LU, Shanghai (CN); Su WANG, Shanghai (CN)

(21) Appl. No.: 18/847,603

(22) PCT Filed: Mar. 9, 2023
(86) PCT No.: PCT/CN2023/080409

§ 371 Date: Sep. 16, 2024

(30) Foreign Application Priority Data
Mar. 16, 2022 (CN) 202210261993.2

(51) Int. Cl. G06F 9/455; G06F 9/48

(52) U.S. Cl. CPC G06F 9/45558; G06F 9/4856; G06F 2009/4557; G06F 2009/45587

(57) ABSTRACT

The present disclosure provides a data processing method, an apparatus, a device and a storage medium. The method includes: providing a standard data storage interface for an application program by adopting a storage client end running in a first virtual machine; receiving a data read-write request sent by the application program through the standard data storage interface; forwarding the data read-write request to a storage service end running in a second virtual machine, so that the storage service end returns a data read-write response result according to the data read-write request, where the first virtual machine is isolated from the second virtual machine. A universal and easy-to-use solution is provided for implementing a universal persistent storage of an application program in the virtualized trusted isolated space scenario, and the data processing cost can be greatly reduced.

### CROSS-REFERENCE TO RELATED APPLICATIONS

The present disclosure is a National Stage of International Application No. PCT/CN2023/080409, filed on Mar. 9, 2023, which claims the priority to Chinese Patent Application No. 202210261993.2 filed to China National Intellectual Property Administration on Mar. 16, 2022 and titled “Data processing method, apparatus, device and storage medium”, the entire content of these applications are incorporated herein by reference.

### TECHNICAL FIELD

The present disclosure relates to the technical field of computers, in particular to a data processing method, an apparatus, a device and a storage medium.

### BACKGROUND

At present, for an application in need of persistent storage, a user needs to modify the application. In the prior art, the software development kit SDK (SDK is a collection of development tools used by a software engineer to create an application for a specific software package, a software framework, a hardware platform, an operating system, etc.) is usually adopted to modify an application to support the need of an application for the persistent storage.

However, the existing solution mentioned above still has the following shortcomings: 1) a user needs to have in-depth understanding and practical experience of a target application, which set a higher requirement for the technical threshold; 2) it takes a lot of work to modify an application by using the software development kit SDK; 3) it is difficult to reuse the modification work using the software development kit SDK, and it needs to repeatedly invest in the modification cost for different applications, which is low in cost performance.

### SUMMARY

Embodiment of the present disclosure provides a data processing method, an apparatus, a device and a storage medium, so as to reduce the data processing cost.

In a first aspect, an embodiment of the present disclosure provides a data processing method, which includes: providing a standard data storage interface for an application program by adopting a storage client end running in a first virtual machine; receiving a data read-write request sent by the application program through the standard data storage interface; forwarding the data read-write request to a storage service end running in a second virtual machine, so that the storage service end returns a data read-write response result according to the data read-write request, where the first virtual machine is isolated from the second virtual machine.

In a second aspect, an embodiment of the present disclosure provides a data processing method, which includes: determining, by a storage service end running in a second virtual machine, a data read-write response result in response to a data read-write request forwarded by a storage client end running in a first virtual machine, where the first virtual machine is isolated from the second virtual machine, and the storage client end is configured to provide a standard data storage interface for an application program and receive the data read-write request sent by the application program through the standard data storage interface; returning the data read-write response result to the storage client end, so that the storage client end returns the data read-write response result to the application program.

In a third aspect, an embodiment of the present disclosure provides a data processing apparatus, which includes an interface providing module configured to provide a standard data storage interface for an application program by adopting a storage client end running in a first virtual machine; a receiving module configured to receive a data read-write request sent by the application program through the standard data storage interface; a forwarding module configured to forward the data read-write request to a storage service end running in a second virtual machine, so that the storage service end returns a data read-write response result according to the data read-write request, where the first virtual machine is isolated from the second virtual machine.

In a fourth aspect, an embodiment of the present disclosure provides a data processing apparatus, which includes a response module configured to make a storage service end running in a second virtual machine determine a data read-write response result in response to a data read-write request forwarded by a storage client end running in a first virtual machine, where the first virtual machine is isolated from the second virtual machine, and the storage client end is configured to provide a standard data storage interface for an application program and receiving the data read-write request sent by the application program through the standard data storage interface; a return module configured to return the data read-write response result to the storage client end, so that the storage client end returns the data read-write response result to the application program.

In a fifth aspect, an embodiment of the present disclosure provides an electronic device, including a memory, a processor, and a communication interface; where an executable code is stored on the memory, and when the executable code is executed by the processor, the processor is caused to at least implement the data processing method as described in the first aspect.

In a sixth aspect, an embodiment of the present disclosure provides a non-transitory machine-readable storage medium, an executable code is stored on the non-transitory machine-readable storage medium, and when the executable code is executed by a processor of an electronic device, the processor is caused to at least implement the data processing method as described in the first aspect.

In the embodiment of the present disclosure, a storage client end running in a first virtual machine is adopted to provide a standard data storage interface for an application program, so that the application program following the standard data storage interface can use a persistent storage service without modification. After the providing the standard data storage interface for the application program by adopting the storage client end running in the first virtual machine, as the first virtual machine is isolated from the second virtual machine, the storage client end receives a data read-write request sent by the application program through the standard data storage interface and then forwards the data read-write request to a storage service end running in the second virtual machine, so that the storage service end returns a data read-write response result according to the data read-write request.

The specific data interaction details between an upper-level application program and the storage service end are shielded by the storage client end, which provides advanced abstraction for the application program, so that the application program running in the first virtual machine can complete data persistent storage by using the standard data storage interface, and the data can be migrated to the virtualization Enclave instance without modification to obtain better security protection. Therefore, through the embodiment of the present disclosure, a universal and easy-to-use solution is provided for implementing a universal persistent storage of an application program in the virtualized trusted isolated space scenario, and the data processing cost can be greatly reduced.

### BRIEF DESCRIPTION OF DRAWINGS

In order to explain the technical solutions in the embodiments of the present disclosure more clearly, the drawings needed in the description of the embodiments will be briefly introduced below. It is evident that the accompanying drawings in the following description are some embodiments of the present disclosure. For those of ordinary skill in the art, other accompanying drawings can be obtained based on these accompanying drawings without creative effort.

FIG. 1 is a flowchart of a data processing method provided by an embodiment of the present disclosure.

FIG. 2 is an architecture diagram of an alternative storage service system provided by an embodiment of the present disclosure.

FIG. 3 is a flowchart of an alternative data processing method provided by an embodiment of the present disclosure.

FIG. 4 is a flowchart of another data processing method provided by an embodiment of the present disclosure.

FIG. 5 is a schematic structural diagram of a data processing apparatus provided by an embodiment of the present disclosure.

FIG. 6 is a schematic structural diagram of another data processing apparatus provided by an embodiment of the present disclosure.

FIG. 7 is a schematic structural diagram of an electronic device provided by an embodiment of the present disclosure.

### DESCRIPTION OF EMBODIMENTS

In order to make the purpose, technical solutions and advantage of the embodiments of the present disclosure more clear, the technical solutions in the embodiments of the present disclosure will be described clearly and completely with the accompanying drawings in the embodiments of the present disclosure. It is evident that the described embodiments are some embodiments of the present disclosure, but not all of the embodiments. Based on the embodiments in the present disclosure, all other embodiments obtained by those of ordinary skill in the art without creative work fall into the protection scope of the present disclosure.

Some embodiments of the present disclosure will be described in detail with reference to the accompanying drawings. In the condition that there is no conflict between the embodiments, the following embodiments and features in the embodiments can be combined with each other. In addition, the sequence of steps in the following method embodiments is only an example, and is not strictly limited.

First, the terms or concepts involved in the embodiments of the present disclosure will be explained:

Virtualization Enclave: a trusted isolated space (Enclave confidential environment, which is a completely isolated, independent and exclusive virtual machine with CPU and memory) is provided inside an ECS (Elastic Compute Service) instance, and the safe operation of a legal software is encapsulated in an Enclave to ensure the confidentiality and integrity of your code and data, so as not to be attacked by a malicious software.

A virtual machine server Hypervisor refers to a kind of middle-tier software running between the physical server and the operating system, which can allow multiple operating systems and applications to share a set of basic physical hardware. The Hypervisor can be regarded as a “meta” operating system in a virtual environment and can coordinate an access to all physical devices and virtual machines on the server. Hypervisors not only coordinates the access of these hardware resources, but also exerts protection among virtual machines. When the server starts and executes the Hypervisor, it will load the operating systems of all virtual machine client ends and allocate a proper amount of memory, CPU, network and disk to each virtual machine.

Trusted Execution Environment (TEE) is a concept put forward by Global Platform (GP). In view of the open environment of a mobile device, the security issue has attracted more and more attention, not only from a terminal user, but also from a service provider, a mobile operator and a chip manufacturer. TEE is an operating environment that coexists with the Rich OS (usually Android, etc.) on a device, and it has its own execution space and provides security service for the Rich OS. From the view point of cost, TEE provides a balance between security and cost.

A primary virtual machine (PVM, Primary VM) refers to the working principle of constructing a confidential computing environment with the virtualization Enclave, which is to split computing resources (including vCPU and memory) within the ECS instance (i.e. primary virtual machine PVM) and create an Enclave VM (EVM for short) as a trusted execution environment.

The Enclave virtual machine (EVM, Enclave VM) refers to the security isolation provided by the underlying virtualization technology, which is isolated from the primary VM and other ECS instances.

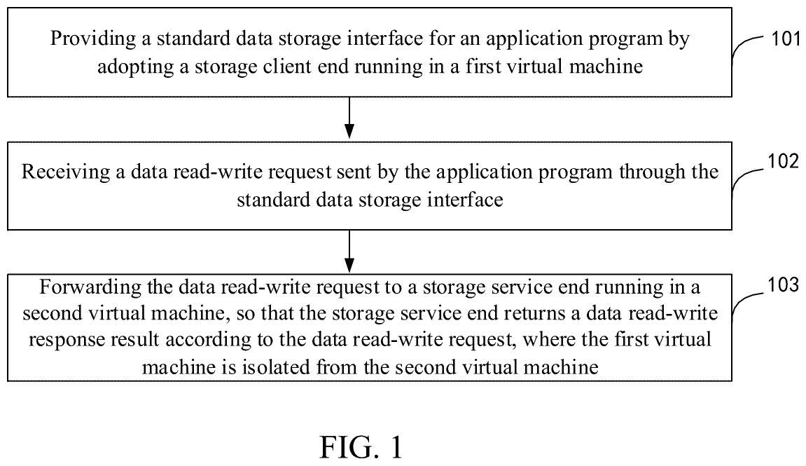

FIG. 1 is a flowchart of a data processing method provided by an embodiment of the present disclosure. As shown in FIG. 1, the method includes the following steps:
101, providing a standard data storage interface for an application program by adopting a storage client end running in a first virtual machine.
102, receiving a data read-write request sent by the application program through the standard data storage interface.
103, forwarding the data read-write request to a storage service end running in a second virtual machine, so that the storage service end returns a data read-write response result according to the data read-write request, where the first virtual machine is isolated from the second virtual machine.

In practical application, the data processing method provided by the embodiment of the present disclosure can be applied to a storage service system in a virtualized trusted isolated space scenario, and the storage service system includes a first virtual machine and a second virtual machine, etc. The data processing method provided by the embodiment of the present disclosure can be executed by the storage client end running in the first virtual machine.

It should be noted that in the embodiment of the present disclosure, the virtualized trusted isolated space Enclave scenario is suitable for an application scenario with a strong protection requirement for sensitive and confidential data, such as a financial service, the Internet, a medical care, etc.

Because data has generally three forms: static data, data in transmission and data in use. The first two can ensure data security through encryption and other means; however, it is very difficult to ensure the security of data in use. At present, confidential computing is generally used to protect the security of data in use.

The trusted execution environment TEE provides a secure execution environment for an authorized secure software (trusted application, TA), and also protects the confidentiality, integrity and access rights of resources and data of TA. In order to ensure the trusted root of TEE itself, TEE must pass a verification during a secure startup and be isolated from the Rich OS. In TEE, each TA is independent of each other, and cannot access each other without authorization.

In the embodiment of the present disclosure, the virtualization Enclave provides a trusted isolated space inside an ECS instance, and encapsulates the safe operation of a legal software in a first virtual machine EVM, thus ensuring the confidentiality and integrity of the user's code and data, so as not to be attacked by a malicious software. In addition, a storage client end is added in the EVM of the virtualization Enclave to provide universal persistent storage service for an upper-level application program, and an existing storage-related application program enables data to migrate to the Enclave instance without modification to obtain better security protection.

In an implementation, the standard data storage interface may be a block device interface or a file system interface. The present disclosure provides a processing method using a universal persistent storage for an application program running in the first virtual machine EVM, that is, a storage client end provides the EVM with a block device interface or a file system interface compatible with a standard protocol, so that the application program following a standard data storage interface, such as a block device interface or a file system interface, can use a persistent storage service without modification.

In an implementation, the application program can be a storage-related application program, such as a database program, a memory program, etc. Taking the application program in the embodiment of the present disclosure being a database program as an example, the trusted operating system currently operated by EVM does not have a persistent storage, and cannot support the operation of the database program requiring a storage interface. The solution of the present disclosure provides a standard data storage interface for the database program running in the EVM environment, such that the database program can run in the secure execution environment without additional development work from a user. Moreover, the solution of the present disclosure has extremely high universality, and only through a small amount of configuration, the application program that needs to use persistent storage can be run in it without modification, so as to obtain higher security protection, so compared with the current way of providing persistent storage service by modifying an application program with SDK, the solution of the present disclosure has extremely low use cost and promotion value.

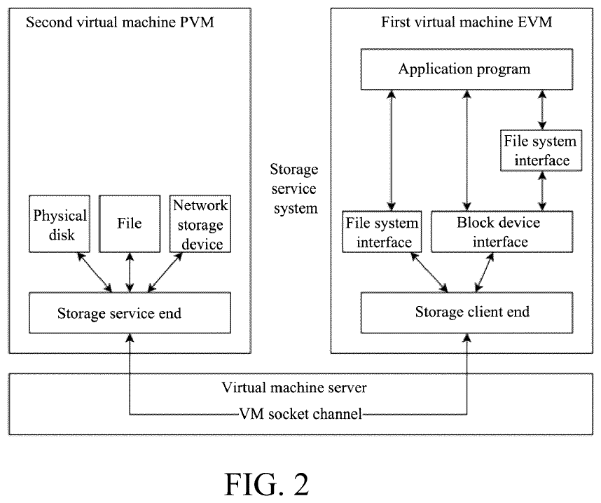

In order to facilitate the understanding of the embodiment of the present disclosure, a practical application scenario is taken as an example to explain. FIG. 2 shows a schematic architecture diagram of an alternative storage service system. The storage service system includes a storage service end running in a second virtual machine PVM and a storage client end running in a first virtual machine EVM, which establish a communication connection through a local channel VM socket of a virtual machine server provided by a virtualized trusted isolated space, and the storage service system shields the details of data interaction based on the VM socket channel, provides an advanced abstract service for an upper-level application, so that an application program running in the EVM can use a standard block device interface or file system interface to complete data persistent storage, and data can be migrated to an Enclave instance without modification to obtain better security protection.

Still as shown in FIG. 2, the storage client end runs in the first virtual machine EVM, and is mainly responsible for providing a standard data storage interface for an upper-level application program running in the first virtual machine EVM, such as a block device interface or a file system interface, and sending a data read-write request sent by the application program through the standard data storage interface to the storage service end. The storage service end runs in the second virtual machine PVM, and is mainly responsible for processing the data read-write request sent by the storage client end, so that the storage service end return a data read-write response result according to the data read-write request. Specifically, the storage service end can use a physical disk, a file or a network storage device as a storage space to store data of the application program in the storage space.

In an alternative embodiment, the providing a standard data storage interface for an application program by adopting a storage client end running in a first virtual machine includes providing a block device interface or a file system interface for the application program by adopting the storage client end so as to be compatible with an existing disk management software and/or a disk encryption software in the first virtual machine.

In a practical application scenario, since the storage client end can provide a standard data storage interface for an upper-level application program, it can be compatible with an existing disk management software (for example, disk partition software, etc.) and/or a disk encryption software in the first virtual machine.

In an alternative embodiment, the providing a standard data storage interface for an application program by adopting a storage client end running in a first virtual machine includes:
formatting the block device interface into a file system interface;
mounting the file system interface obtained through formatting into the first virtual machine for use by the application program.

In another practical application scenario, if the storage client end can provide the standard data storage interface for the upper-level application program as a block device interface, and in order to facilitate the use of the upper-level application program to provide the data storage service, the block device interface can also be formatted as a file system interface of main stream, and then mounted in the EVM for use by the upper-level application program. In addition, in the embodiment of the present disclosure, an existing disk encryption software in the EVM can also be used compatibly on the basis of the block device interface provided by the storage client end, thus realizing the encryption persistence storage service for the EVM.

By adopting the solution provided by the embodiment of the present disclosure, in the EVM, not only an existing application program can be used to encrypt data, but also the upper-level application program can be transparently encrypted and decrypted, which can be well compatible with an existing storage software ecology.

In an alternative embodiment, before providing a standard data storage interface for an application program by adopting a storage client end running in a first virtual machine, the method further includes:
establishing a communication connection between the storage client end and the storage service end through a local channel of a virtual machine server provided by a virtualized trusted isolated space.

It is easy to note that according to the alternative embodiment provided by the present disclosure, secure communication is conducted between PVM and EVM through the local VM socket channel provided by the virtual machine server, that is, the secure communication mechanism provided by the Hypervisor is completely reused. The application program can run in a secure execution environment without additional development work from a user.

Understandably, the working principle of building a confidential computing environment by using the virtualization Enclave is to split the computing resources (including vCPU and memory) in the ECS instance (i.e. the second virtual machine PVM) and re-create a first virtual machine Enclave VM (EVM for short) as a trusted execution environment. In the embodiment of the present disclosure, the security guarantee of the first virtual machine EVM is embodied in the following aspects:
first of all, security isolation is provided by the underlying virtualization technology, that is, the first virtual machine EVM and the second virtual machine PVM are isolated from each other and from other ECS instances;
secondly, the first virtual machine EVM runs an independent and customized trusted operating system, without persistent storage, interactive connection or external network path, and only allows communication with the second virtual machine PVM through the local secure channel (based on the VM socket channel), thus minimizing the attack surface. Furthermore, a user can put an application program involving confidential data into the EVM to run, and interact with the stored data running on the PVM through a secure call.

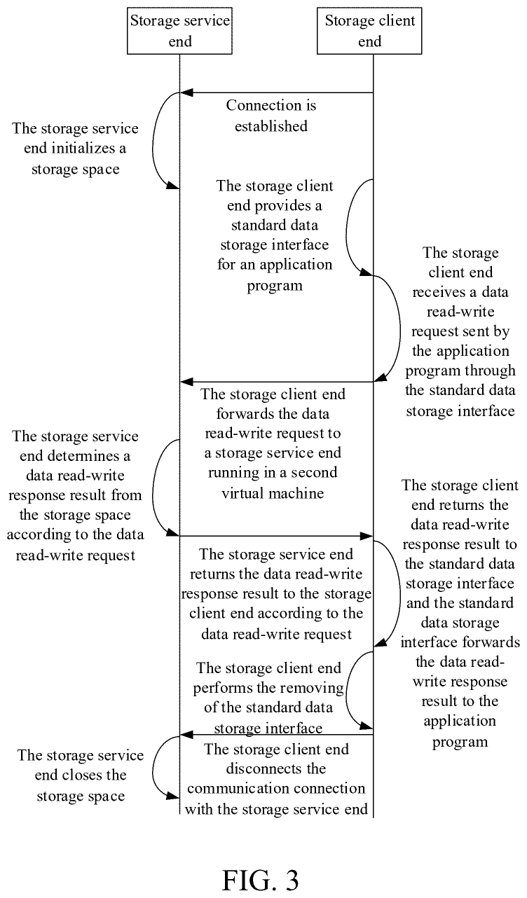

FIG. 3 shows the flow chart of an alternative data processing method. As an alternative embodiment, in the specific implementation process of providing a data persistent storage service for the application program, as shown in FIG. 3, firstly, after the establishing the communication connection with the storage service end by the storage client end through the local channel of the virtual machine server provided by the virtualized trusted isolated space, the storage service end initializes a storage space (which can be understood as initializing a storage backend for an application program, for example, the storage space can be at least one of the following: a physical disk, a file or a network storage device) to start to provide a data persistent storage service for the application program.

Secondly, the step of providing a standard data storage interface for an application program by adopting a storage client end running in a first virtual machine, can be understood as creating a storage front end for the application program. The data read-write request sent by the application program is sent to the standard data storage interface; further, the storage client end receives the data read-write request sent by the application program through the standard data storage interface. Then, forwarding the data read-write request to a storage service end running in a second virtual machine; in an alternative embodiment, the forwarding the data read-write request to the storage service end running in the second virtual machine can be implemented by adopting the following method step: forwarding the data read-write request to the storage service end by adopting a local VM socket channel of the virtual machine server, so that the storage service end returns a data read-write response result according to the data read-write request.

In an alternative embodiment, after forwarding the data read-write request to a storage service end running in a second virtual machine so that the storage service end returns a data read-write response result according to the data read-write request, the method further includes:
removing the standard data storage interface;
disconnecting the communication connection with the storage service end, where after the disconnecting the communication connection, the storage service end closes the storage space to stop providing the data persistent storage service for the application program.

Still as shown in FIG. 3, after forwarding the data read-write request to a storage service end running in a second virtual machine, the storage service end determines a read-write response result from a storage space according to the data read-write request; the storage service end returns the data read-write response result to the storage client end according to the data read-write request; after receiving the data read-write response result returned by the storage service end according to the data read-write request, the storage client end returns the data read-write response result to the standard data storage interface, and then the standard data storage interface forwards the data read-write response result to an application program running in the EVM. For the safe operation of the virtualization Enclave, the standard data storage interface is removed after the data processing interaction flow is completed, and the communication connection with the storage service end is directly disconnected; and after the communication connection is disconnected, the storage service end closes the storage space to stop providing the data persistent storage service for the application program.

Therefore, through the embodiment of the present disclosure, the specific data interaction details between the upper-level application program and the storage service end is shielded by the storage client end, which provides advanced abstraction for the application program, so that the application program running in the first virtual machine can complete data persistent storage by using the standard data storage interface, and the data can be migrated to the virtualization Enclave instance without modification to obtain better security protection. Therefore, through the embodiment of the present disclosure, a universal and easy-to-use solution is provided for implementing a universal persistent storage of an application program in the virtualized trusted isolated space scenario, and the data processing cost can be greatly reduced.

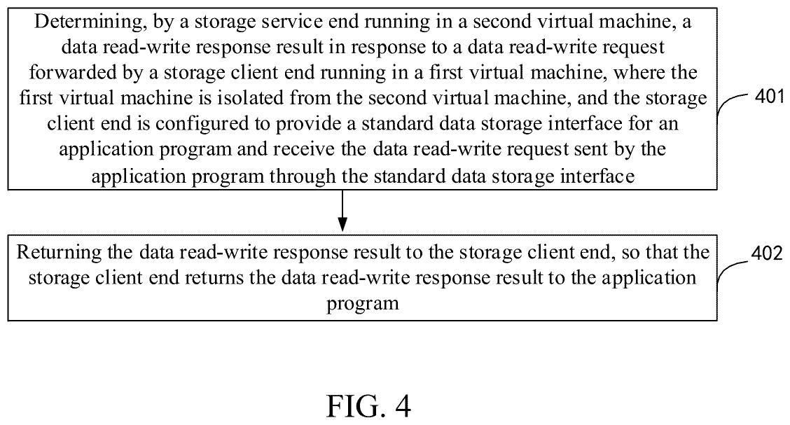

FIG. 4 is a flowchart of another data processing method provided by an embodiment of the present disclosure. As shown in FIG. 4, the method includes the following steps:
401, determining, by a storage service end running in a second virtual machine, a data read-write response result in response to a data read-write request forwarded by a storage client end running in a first virtual machine, where the first virtual machine is isolated from the second virtual machine, and the storage client end is configured to provide a standard data storage interface for an application program and receive the data read-write request sent by the application program through the standard data storage interface;
402, returning the data read-write response result to the storage client end, so that the storage client end returns the data read-write response result to the application program.

In practical application, the data processing method provided by the embodiment of the present disclosure can be applied to a storage service system in a virtualized trusted isolated space scenario, and the storage service system includes a first virtual machine and a second virtual machine, etc. The data processing method provided by the embodiment of the present disclosure can be executed by the storage service end running in the second virtual machine.

It should be noted that in the embodiment of the present disclosure, the virtualized trusted isolated space Enclave scenario is suitable for an application scenario with a strong protection requirement for sensitive and confidential data, such as a financial service, the Internet, a medical care, etc.

Because data has generally three forms: static data, data in transmission and data in use. The first two can ensure data security through encryption and other means; however, it is very difficult to ensure the security of data in use. At present, confidential computing is generally used to protect the security of data in use.

The trusted execution environment TEE provides a secure execution environment for an authorized secure software (trusted application, TA), and also protects the confidentiality, integrity and access rights of resources and data of TA. In order to ensure the trusted root of TEE itself, TEE must pass a verification during a secure startup and be isolated from the Rich OS. In TEE, each TA is independent of each other, and cannot access each other without authorization.

In the embodiment of the present disclosure, the virtualization Enclave provides a trusted isolated space inside an ECS instance, and encapsulates the safe operation of a legal software in a first virtual machine EVM, thus ensuring the confidentiality and integrity of the user's code and data, so as not to be attacked by a malicious software. In addition, a storage client end is added in the EVM of the virtualization Enclave to provide a universal persistent storage service for an upper-level application program, and an existing storage-related application program enable data to migrate to the Enclave instance without modification to obtain better security protection.

In an implementation, the standard data storage interface may be a block device interface or a file system interface. The present disclosure provides a processing method using a universal persistent storage for an application program running in the first virtual machine EVM, that is, a storage client end provides the EVM with a block device interface or a file system interface compatible with a standard protocol, so that the application program following a standard data storage interface, such as a block device interface or a file system interface, can use a persistent storage service without modification.

In an implementation, the application program can be a storage-related application program, such as a database program, a memory program, etc. Taking the application program in the embodiment of the present disclosure being a database program as an example, the trusted operating system currently operated by EVM does not have a persistent storage, and cannot support the operation of the database program requiring a storage interface. The solution of the present disclosure provides a standard data storage interface for the database program running in the EVM environment, such that the database program can run in the secure execution environment without additional development work from a user. Moreover, the solution of the present disclosure has extremely high universality, and only through a small amount of configuration, the application program that needs to use persistent storage can be run in it without modification, so as to obtain higher security protection, so compared with the current way of providing persistent storage service by modifying an application program with SDK, the solution of the present disclosure has extremely low use cost and promotion value.

In order to facilitate the understanding of the embodiment of the present disclosure, a practical application scenario is taken as an example to explain. FIG. 2 shows an architecture diagram of a storage service system, in which a storage service end runs in the PVM and a storage client end runs in the EVM. The storage service end and the storage client end establish a communication connection through a local channel VM socket of a virtual machine server provided by a virtualized trusted isolated space, and the storage service system shields the details of data interaction based on the VM socket channel, provides an advanced abstract service for an upper-level application, so that an application program running in the EVM can use a standard block device interface or file system interface to complete data persistent storage, and data can be migrated to an Enclave instance without modification to obtain better security protection.

Still as shown in FIG. 2, the storage client end runs in the first virtual machine EVM, and is mainly responsible for providing a standard data storage interface for an upper-level application program running in the first virtual machine EVM, such as a block device interface or a file system interface, and sending a data read-write request sent by the application program through the standard data storage interface to the storage service end. The storage service end runs in the second virtual machine PVM, and is mainly responsible for processing the data read-write request sent by the storage client end, so that the storage service end return a data read-write response result according to the data read-write request. Specifically, the storage service end can use a physical disk, a file or a network storage device as a storage space to store data of the application program in the storage space.

In an alternative embodiment, before the determining, by a storage service end running in a second virtual machine, a data read-write response result in response to a data read-write request forwarded by a storage client end running in a first virtual machine, the method further includes:
establishing a communication connection between the storage client end and the storage service end through a local channel of a virtual machine server provided by a virtualized trusted isolated space;
initializing a storage space to start to provide a data persistent storage service for the application program, where the storage space includes at least one of the following: a physical disk, a file or a network storage device.

It is easy to note that according to the alternative embodiment provided by the present disclosure, secure communication is conducted between the PVM and the EVM through the local VM socket channel provided by the virtual machine server, that is, the secure communication mechanism provided by the Hypervisor is completely reused. The application program can run in a secure execution environment without additional development work from a user.

Understandably, the working principle of building a confidential computing environment by using the virtualization Enclave is to split the computing resources (including vCPU and memory) in the ECS instance (i.e. the second virtual machine PVM) and re-create a first virtual machine Enclave VM (EVM for short) as a trusted execution environment. In the embodiment of the present disclosure, the security guarantee of the first virtual machine EVM is embodied in the following aspects:
first of all, security isolation is provided by the underlying virtualization technology, that is, the first virtual machine EVM and the second virtual machine PVM are isolated from each other and from other ECS instances;
secondly, the first virtual machine EVM runs an independent and customized trusted operating system, without persistent storage, interactive connection or external network path, and only allows communication with the second virtual machine PVM through the local secure channel (based on the VM socket channel), thus minimizing the attack surface. Furthermore, a user can put an application program involving confidential data into the EVM to run, and interact with the stored data running on the PVM through a secure call.

As an alternative embodiment, in the specific implementation process of providing a data persistent storage service for the application program, still as shown in FIG. 3, firstly, after the establishing the communication connection with the storage service end by the storage client end through the local channel of the virtual machine server provided by the virtualized trusted isolated space, the storage service end initializes a storage space (which can be understood as initializing a storage backend for an application program, for example, at least one of the following: a physical disk, a file or a network storage device) to start to provide a data persistent storage service for the application program.

Secondly, the step of providing a standard data storage interface for an application program by adopting a storage client end running in a first virtual machine, can be understood as creating a storage front end for the application program, and then the data read-write request sent by the application program through the standard data storage interface can be received. Furthermore, forwarding the data read-write request to a storage service end running in a second virtual machine; in an alternative embodiment, the forwarding the data read-write request to the storage service end running in the second virtual machine can be implemented by adopting the following method step: forwarding the data read-write request to the storage service end by adopting a local VM socket channel of the virtual machine server, so that the storage service end returns a data read-write response result according to the data read-write request.

In an alternative embodiment, the determining, by a storage service end running in a second virtual machine, a data read-write response result in response to a data read-write request forwarded by a storage client end running in a first virtual machine includes: obtaining the data read-write response result from the storage space in response to the data read-write request.

In an alternative embodiment, the method further includes:
closing the storage space after the communication connection with the storage client end is disconnected, so as to stop providing the data persistent storage service for the application program.

Still as shown in FIG. 3, after forwarding the data read-write request to a storage service end running in a second virtual machine and receiving the data read-write response result returned by the storage service end according to the data read-write request, returning the data read-write response result to the application program running in the EVM. For the safe operation of the virtualization Enclave, the standard data storage interface is removed after the data processing interaction flow is completed, and the communication connection with the storage service end is directly disconnected; and after the communication connection is disconnected, the storage service end closes the storage space to stop providing the data persistent storage service for the application program.

Therefore, through the embodiment of the present disclosure, the storage space adopted by the storage service end running in the second virtual machine is taken as a storage backend, which provides the data persistent storage service for the application program; the specific data interaction details between the upper-level application program and the storage service end is shielded by the storage client end, which provides advanced abstraction for the application program, so that the application program running in the first virtual machine can complete data persistent storage by using the standard data storage interface, and the data can be migrated to the virtualization Enclave instance without modification to obtain better security protection. Therefore, through the embodiment of the present disclosure, a universal and easy-to-use solution is provided for implementing a universal persistent storage of an application program in the virtualized trusted isolated space scenario, and the data processing cost can be greatly reduced.

A data processing apparatus of one or more embodiments of the present disclosure will be described in detail below. Those skilled in the art can understand that these apparatuses can be configured by using commercially available hardware components according to the steps taught in this solution.

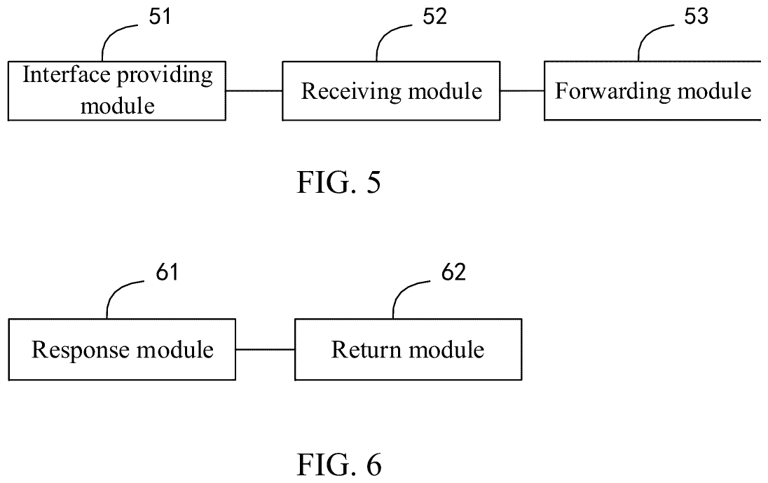

FIG. 5 is a schematic structural diagram of a data processing apparatus provided by an embodiment of the present disclosure. As shown in FIG. 5, the apparatus includes an interface providing module 51, a receiving module 52, and a forwarding module 53.

The interface providing module 51 is configured to provide a standard data storage interface for an application program by adopting a storage client end running in a first virtual machine.

The receiving module 52 is configured to receive a data read-write request sent by the application program through the standard data storage interface.

The forwarding module 53 is configured to forward the data read-write request to a storage service end running in a second virtual machine, so that the storage service end returns a data read-write response result according to the data read-write request, where the first virtual machine is isolated from the second virtual machine.

In an implementation, the interface providing module 51 is specifically configured to provide a block device interface or a file system interface for the application program by adopting the storage client end, so as to be compatible with an existing disk management software and/or a disk encryption software in the first virtual machine.

In an implementation, the interface providing module 51 is also specifically configured to format the block device interface into a file system interface; mounting the file system interface obtained through formatting into the first virtual machine for use by the application program.

In an implementation, the data processing apparatus further includes a connecting module configured to establish a communication connection between the storage client end and the storage service end through a local channel of a virtual machine server provided by a virtualized trusted isolated space, where after the communication connection is established, the storage service end initializes a storage space to start to provide a data persistent storage service for the application program, and the storage space includes at least one of the following: a physical disk, a file or a network storage device.

In an implementation, the forwarding module 53 is specifically configured to forward the data read-write request to the storage service end by adopting the local channel of the virtual machine server.

In an implementation, the data processing apparatus further includes a deletion module configured to remove the standard data storage interface; disconnect the communication connection with the storage service end, where after the communication connection is disconnected, the storage service end closes the storage space to stop providing the data persistent storage service for the application program.

The apparatus shown in FIG. 5 can execute the steps provided in the previous embodiments, and the detailed execution process and technical effects are described in the previous embodiments, which will not be repeated here.

FIG. 6 is a schematic structural diagram of another data processing apparatus provided by an embodiment of the present disclosure. As shown, the apparatus includes a response module 61 and a return module 62.

The response module 61 is configured to make a storage service end running in a second virtual machine determine a data read-write response result in response to a data read-write request forwarded by a storage client end running in a first virtual machine, where the first virtual machine is isolated from the second virtual machine, and the storage client end is configured to provide a standard data storage interface for an application program and receiving the data read-write request sent by the application program through the standard data storage interface.

The return module 62 is configured to return the data read-write response result to the storage client end, so that the storage client end returns the data read-write response result to the application program.

In an implementation, the data processing apparatus further includes a connecting module configured to establish a communication connection between the storage client end and the storage service end through a local channel of a virtual machine server provided by a virtualized trusted isolated space; initializing a storage space to start to provide a data persistent storage service for the application program, where the storage space includes at least one of the following: a physical disk, a file or a network storage device.

In an implementation, the response module 61 is specifically configured to obtain the data read-write response result from the storage space in response to the data read-write request.

In an implementation, the data processing apparatus further includes a deletion module configured to close the storage space after the communication connection with the storage client end is disconnected, so as to stop providing the data persistent storage service for the application program.

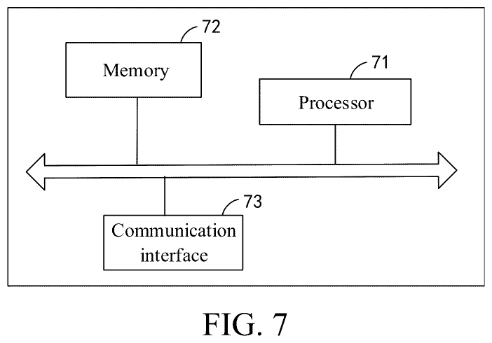

The apparatus shown in FIG. 6 can execute the steps provided in the previous embodiments, and the detailed execution process and technical effects are described in the previous embodiments, which will not be repeated here. In one possible design, the structure of the data processing apparatus shown in FIG. 5 or FIG. 6 can be implemented as an electronic device. As shown in FIG. 7, the electronic device may include a processor 71, a memory 72, and a communication interface 73. The memory 72 stores an executable code, which, when executed by the processor 71, enables the processor 71 to at least implement the data processing method provided in the aforementioned embodiments.

In addition, an embodiment of the present disclosure provides a non-transitory machine-readable storage medium, on which an executable code is stored, and when the executable code is executed by a processor of an electronic device, the processor can at least implement the data processing method provided in the previous embodiments.

The apparatus embodiments described above are only schematic, where the network elements described above as separate components may or may not be physically separated. Some or all of the modules can be selected according to actual needs to implement the purpose of the solution of the embodiment. Those of ordinary skill in the art can understand and implement it without creative labor.

From the description of the above embodiments, those skilled in the art can clearly understand that each embodiment can be implemented by adding a necessary general hardware platform, or by combining hardware and software. Based on this understanding, the essence of the above technical solutions or the part that has contributed to the prior art can be embodied in the form of a computer product, and the present disclosure can take the form of a computer program product implemented on one or more computer-usable storage medium (including but not limited to disk storage, CD-ROM, optical storage, etc.) containing a computer-usable program code.

Finally, it should be explained that the above embodiments are only used to illustrate the technical solutions of the present disclosure, but not to limit them. Although the present disclosure has been described in detail with reference to the foregoing embodiments, those skilled in the art should understand that it is still possible to modify the technical solutions described in the foregoing embodiments, or to replace some technical features with equivalents; however, these modifications or substitutions do not make the essence of the corresponding technical solutions deviate from the spirit and scope of the technical solutions of various embodiments of the present disclosure.

1. A data processing method, comprising:
providing a standard data storage interface for an application program by adopting a storage client end running in a first virtual machine;
receiving a data read-write request sent by the application program through the standard data storage interface;
forwarding the data read-write request to a storage service end running in a second virtual machine, so that the storage service end returns a data read-write response result according to the data read-write request, wherein the first virtual machine is isolated from the second virtual machine.

2. The method according to claim 1, wherein the providing a standard data storage interface for an application program by adopting a storage client end running in a first virtual machine comprises:
providing a block device interface or a file system interface for the application program by adopting the storage client end so as to be compatible with an existing disk management software and/or a disk encryption software in the first virtual machine.

3. The method according to claim 2, wherein the providing a standard data storage interface for an application program by adopting a storage client end running in a first virtual machine comprises:
formatting the block device interface into a file system interface;
mounting the file system interface obtained through formatting into the first virtual machine for use by the application program.

4. The method according to claim 1, wherein before the providing a standard data storage interface for an application program by adopting a storage client end running in a first virtual machine, the method further comprises:
establishing a communication connection between the storage client end and the storage service end through a local channel of a virtual machine server provided by a virtualized trusted isolated space, wherein after the communication connection is established, the storage service end initializes a storage space to start to provide a data persistent storage service for the application program, and the storage space comprises at least one of the following: a physical disk, a file or a network storage device.

5. The method according to claim 4, wherein the forwarding the data read-write request to a storage service end running in a second virtual machine comprises:
forwarding the data read-write request to the storage service end by adopting the local channel of the virtual machine server.

6. The method according to claim 1, wherein after the forwarding the data read-write request to a storage service end running in a second virtual machine, so that the storage service end returns a data read-write response result according to the data read-write request, the method further comprises:
removing the standard data storage interface;
disconnecting the communication connection with the storage service end, wherein after the communication connection is disconnected, the storage service end closes the storage space to stop providing the data persistent storage service for the application program.

7. A data processing method, comprising:
determining, by a storage service end running in a second virtual machine, a data read-write response result in response to a data read-write request forwarded by a storage client end running in a first virtual machine, wherein the first virtual machine is isolated from the second virtual machine, and the storage client end is configured to provide a standard data storage interface for an application program and receive the data read-write request sent by the application program through the standard data storage interface;
returning the data read-write response result to the storage client end, so that the storage client end returns the data read-write response result to the application program.

8. The method according to claim 7, wherein before the determining, by a storage service end running in a second virtual machine, a data read-write response result in response to a data read-write request forwarded by a storage client end running in a first virtual machine, the method further comprises:
establishing a communication connection between the storage client end and the storage service end through a local channel of a virtual machine server provided by a virtualized trusted isolated space;
initializing a storage space to start to provide a data persistent storage service for the application program, wherein the storage space comprises at least one of the following: a physical disk, a file or a network storage device.

9. The method according to claim 8, wherein the determining, by a storage service end running in a second virtual machine, a data read-write response result in response to a data read-write request forwarded by a storage client end running in a first virtual machine comprises:
obtaining the data read-write response result from the storage space in response to the data read-write request.

10. The method according to claim 8, wherein the method further comprises:
closing the storage space after the communication connection with the storage client end is disconnected so as to stop providing the data persistent storage service for the application program.

11-12. (canceled)

13. An electronic device comprising: a memory, a processor, and a communication interface; wherein an executable code is stored on the memory, and when the executable code is executed by the processor, the processor is caused to execute the following operations:
providing a standard data storage interface for an application program by adopting a storage client end running in a first virtual machine;
receiving a data read-write request sent by the application program through the standard data storage interface;
forwarding the data read-write request to a storage service end running in a second virtual machine, so that the storage service end returns a data read-write response result according to the data read-write request, wherein the first virtual machine is isolated from the second virtual machine.

14. A non-transitory machine-readable storage medium, wherein an executable code is stored on the non-transitory machine-readable storage medium, and when the executable code is executed by a processor of an electronic device, the processor is caused to execute the data processing method according to claim 1.

15. The electronic device according to claim 13, wherein the processor is further caused to execute the following operations:
providing a block device interface or a file system interface for the application program by adopting the storage client end so as to be compatible with an existing disk management software and/or a disk encryption software in the first virtual machine.

16. The electronic device according to claim 15, wherein the processor is further caused to execute the following operations:
formatting the block device interface into a file system interface;
mounting the file system interface obtained through formatting into the first virtual machine for use by the application program.

17. The electronic device according to claim 13, wherein the processor is further caused to execute the following operations:
establishing a communication connection between the storage client end and the storage service end through a local channel of a virtual machine server provided by a virtualized trusted isolated space, wherein after the communication connection is established, the storage service end initializes a storage space to start to provide a data persistent storage service for the application program, and the storage space comprises at least one of the following: a physical disk, a file or a network storage device.

18. An electronic device comprising: a memory, a processor, and a communication interface; wherein an executable code is stored on the memory, and when the executable code is executed by the processor, the processor is caused to execute the data processing method according to claim 7.

19. The electronic device according to claim 18, wherein the processor is further caused to execute the following operations:
establishing a communication connection between the storage client end and the storage service end through a local channel of a virtual machine server provided by a virtualized trusted isolated space;
initializing a storage space to start to provide a data persistent storage service for the application program, wherein the storage space comprises at least one of the following: a physical disk, a file or a network storage device.

20. The electronic device according to claim 19, wherein the processor is further caused to execute the following operations:
obtaining the data read-write response result from the storage space in response to the data read-write request.

21. The non-transitory machine-readable storage medium according to claim 14, wherein the processor is further caused to execute the following operations:
providing a block device interface or a file system interface for the application program by adopting the storage client end so as to be compatible with an existing disk management software and/or a disk encryption software in the first virtual machine.

22. A non-transitory machine-readable storage medium, wherein an executable code is stored on the non-transitory machine-readable storage medium, and when the executable code is executed by a processor of an electronic device, the processor is caused to execute the data processing method according to claim 7.
